(19) United States
(12) Patent Application Publication
(10) Pub. No.: US 2026/0187992 A1
(43) Pub. Date: Jul. 2, 2026

(54) DEEP LEARNING-BASED REAL-TIME OBJECT TRACKING SYSTEM AND METHOD FOR MINIMIZING PERFORMANCE DEGRADATION IN MULTI-STREAM PROCESSING

(71) Applicant: Korea Electronics Technology Institute, Seongnam-si (KR)

(72) Inventors: Ki Woong KWON, Seoul (KR); Seung Hyeon PARK, Yongin-si (KR); Sang Hun KIM, Suwon-si (KR); Taek Won CHUNG, Hwaseong-si (KR)

(73) Assignee: Korea Electronics Technology Institute, Seongnam-si (KR)

(21) Appl. No.: 19/003,358

(22) Filed: Dec. 27, 2024

(51) Int. Cl. G06V 10/82; G06T 7/246; G06V 20/52

(52) U.S. Cl. CPC G06V 10/82; G06T 7/246; G06V 20/52; G06T 2207/10016; G06T 2207/20084

(57) ABSTRACT

There is provided a deep learning-based real-time object tracking system and method for minimizing performance degradation in multi-stream processing. A real-time object tracking method according to an embodiment of the disclosure may determine whether a moving object exists in a streaming video, when it is determined that the moving object exists, may record the streaming video and store in a file until it is determined that the moving object does not exist, and may detect and track the moving object in the streaming video stored in the file. Accordingly, it is determined whether a moving object exists simply by comparing pixels, so that the occupation of limited computing resources (GPU) may be minimized, and videos are recorded and stored as a file when it is determined that the moving object exists, and video files are processed in sequence when there is no occupation of computing resources, so that it is possible to track the moving object at a high level even in multi-stream processing.

### BACKGROUND

### Field

The disclosure relates to a deep learning-based real-time object tracking technology, and more particularly, to a method for efficiently managing computing resources (a central processing unit (CPU), a graphical processing unit (GPU), etc.) which are necessary for deep learning-based real-time object tracking.

### Description of Related Art

Related-art convolutional neural network (CNN)-based You Only Look Once (YOLO) in the real-time object tracking field is widely used due to its high accuracy and high speed. However, YOLO requires additional computing resources to process multi-streams generated by a plurality of cameras without degrading frame per second (FPS) since the maximum number of frames (FPS) to be processed per second is determined according to the scale of computing resources owned.

While it is possible to reduce FPS of individual cameras without adding computing resources, stable real-time object tracking requires FPS of a specific level or higher (typically, 30 or more), and hence, adding computing resources is unavoidable as the number of streams to be processed increases.

However, high costs may be required for adding computing resources, and, in order to use object tracking technologies in industry, it is necessary to develop technologies that can effectively manage limited computing resources to process multi-streams, and can minimize performance degradation without adding computing resources.

### SUMMARY

The disclosure has been developed in order to address the above-discussed deficiencies of the prior art, and an object of the disclosure is to provide a method which minimizes occupation of limited computing resources by determining whether a moving object exists in deep learning-based real-time object tracking by comparing pixels between a current frame and a previous frame, rather than determining by a deep-learning model, and minimizes performance degradation even in multi-stream processing by recording a video and storing in a file when the moving object exists and processing video files in sequence when there is no occupation of computing resources.

According to an embodiment of the disclosure to achieve the above-described object, a real-time object tracking method may include: a step of determining whether a moving object exists in a streaming video; a step of, when it is determined that the moving object exists, recording the streaming video and storing in a file until it is determined that the moving object does not exist; and a step of detecting and tracking the moving object in the streaming video stored in the file.

The step of determining may include determining whether the moving object exists through a pixel difference between a current frame and a previous frame of the streaming video.

The step of determining may include: when the pixel difference is less than a threshold value, determining that the moving object does not exist; and, when the pixel difference is greater than or equal to the threshold value, determining that the moving object exists.

The threshold value may be variable based on a moving object tracking failure rate.

The pixel difference may be a mean squared error (MSE) or a running Gaussian average (RGA).

The step of recording may include, when a difference between a most recent time at which it is determined that the moving object exists and a current time exceeds a defined time, determining that the moving object which has existed does not exist.

At the step of recording, information on a camera that makes the video, a recording start time, and a recording duration may be included in a name of the file.

At the step of recording, the files may be stored in a queue in the order that the files are generated, and the step of detecting and tracking may include processing the files stored in the queue in sequence when there is no occupation of computing resources.

The step of detecting and tracking may include detecting and tracking the moving object by using a deep learning-based artificial neural network.

According to another aspect of the disclosure, there is provided a real-time object tracking system including: a communication unit configured to receive a streaming video; and a processor configured to determine whether a moving object exists in the received streaming video, when it is determined that the moving object exists, to record the streaming video and store in a file until it is determined that the moving object does not exist, and to detect and track the moving object in the streaming video stored in the file.

According to still another aspect of the disclosure, there is provided a real-time object tracking method including: a step of generating a streaming video; a step of determining whether a moving object exists in the generated streaming video; a step of, when it is determined that the moving object exists, recording the streaming video and storing in a file until it is determined that the moving object does not exist; and a step of detecting and tracking the moving object in the streaming video stored in the file.

As described above, according to embodiments of the disclosure, it is determined whether a moving object exists simply by comparing pixels, so that the occupation of limited computing resources (GPU) may be minimized, and videos are recorded and stored as a file when it is determined that the moving object exists, and video files are processed in sequence when there is no occupation of computing resources, so that it is possible to track the moving object at a high level even in multi-stream processing.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a deep learning-based real-time object tracking method;

FIG. 2 is a view illustrating a YOLO artificial neural network structure;

FIG. 3 is a view illustrating a SORT structure;

FIG. 4 is a view illustrating comparison in video processing performance between a method according to an embodiment of the disclosure, and a related-art method;

FIG. 5 is a flowchart of a deep learning-based real-time object tracking method;

FIG. 6 is a view illustrating a real-time object monitoring system; and

FIG. 7 is a view illustrating a deep learning-based real-time object tracking system.

### DETAILED DESCRIPTION

Hereinafter, the disclosure will be described in more detail with reference to the drawings.

Embodiments of the disclosure propose a deep learning-based real-time object tracking system and method which minimizes performance degradation in multi-stream processing. The disclosure relates to a technology that efficiently manages computing resources necessary for deep learning-based real-time object tracking and provides real-time object tracking performance of a specific level or more without adding computing resources even when multi-streams generated by a plurality of cameras are processed.

Compared to a related-art technology that determines whether a moving object exists in video frames through a deep learning model (YOLO, etc.) and continuously occupies computing resources, the method disclosed in embodiments of the disclosure may determine whether a moving object exists in video frames by comparing pixels between a current frame and a previous frame, and may use a deep learning model only when the moving object exists, so that computing resources are not continuously occupied.

In addition, compared to a reference technology that inevitably causes a frame loss when the number of multi-streaming frames to be processed instantaneously increases, the method disclosed in embodiments of the disclosure may record a video and store the same as a file once when it is determined that an object exists in video frames, and may process video files in sequence when there is no occupation of computing resources, so that a frame loss does not occur even when the number of video frames instantaneously increases.

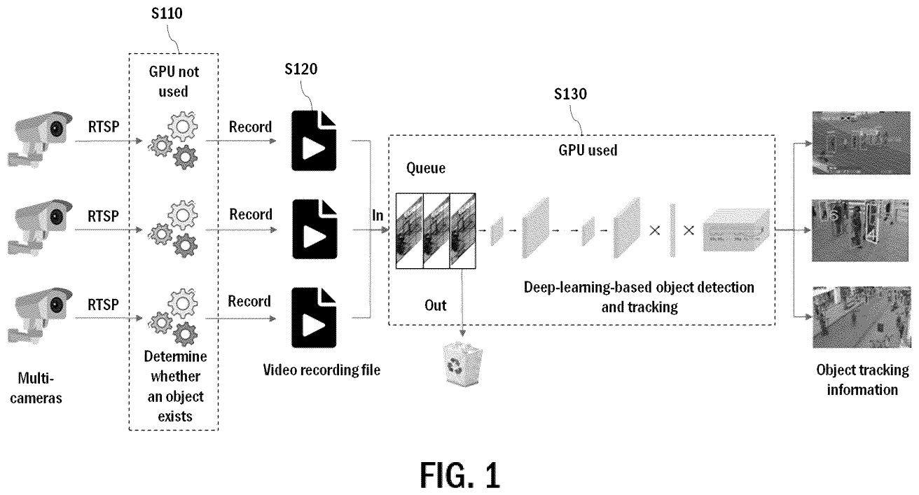

FIG. 1 is a view illustrating a flow of a deep learning-based real-time object tracking method according to an embodiment of the present disclosure. The real-time object tracking method according to an embodiment of the disclosure may include a step of determining whether a moving object exists (S110), a step of recording videos (S120), and a step of detecting and tracking the object (S130).

In an embodiment of the disclosure, only when it is determined that a moving object exists in video streams, object detection and tracking may be performed by using deep learning, so that the time for which computing resources are occupied for stream processing may be reduced and more camera streaming videos may be processed without performance degradation.

### 1) Step of Determining Whether a Moving Object Exists (S110)

Streaming videos of cameras may be collected through a real-time streaming protocol (RTSP). The RTSP is a network control protocol that is designed for the purpose of controlling a streaming media server, and defines communication regulations for transmitting and receiving voices or videos in real time, and is widely used for real-time streaming.

It is determined whether a moving object exists by comparing pixels between a current frame and a previous frame in video frames coming in real time. When the pixel difference between the previous frame and the current frame is relatively small, it may be determined that there is no moving object, but, when the pixel difference between the previous frame and the current frame is relatively great, it may be determined that there is a moving object.

It may be possible to use a mean squared error (MSE) or a running Gaussian average (RGA) to determine whether the pixel difference between the previous frame and the current frame is great or small.

The MSE may be calculated through the following equation, and a threshold value may be set and it may be determined that a moving object exists when the MSE is greater than the threshold value:

$$MSE = \frac{{\sum }_{i = 1}^{n} {( prevFrame - curFrame )}^{2}}{n}$$

where prevFrame is pixel (R, G, B) values of a previous frame, curFrame is pixel (R, G, B) values of a current frame, and n is the number of pixels (R, G, B).

The RGA is a typical method used for separating a background and objects, and it may be determined whether a specific pixel is a pixel that is included in an object through the following equation, and likewise, a threshold value may be set, and it may be determined that a moving object exists when the number of pixels recognized as a moving object is greater than the threshold value:

$$\frac{\vert ( {I}_{t} - {μ}_{t} ) \vert}{{σ}_{t}} > k$$

where Iₜ is a pixel (R, G, B) value at a time t,

$${μ}_{t} = {pI}_{t} + {( 1 - p )}_{{μ}_{t - 1}} {σ}_{t} = \sqrt{{( {I}_{t} - {μ}_{t} )}^{2} p + ( 1 - p ) {σ}_{t - 1}^{2}} ,$$

pₜ is a weight that is used for updating a moving average (typically, 0.01), and kₜ is a parameter for adjusting an object sensing sensitivity (typically, 2.5).

In the two cases above, a fixed threshold value may be used, but, by finding an appropriate value for an environment where cameras are installed, the accuracy of determination of the presence/absence of a moving object may increase. For example, when a moving object is frequently missed in a specific application, that is, when tracking of a moving object frequently fails, the threshold value may be set to a lower value, such that video files are stored even in response to a small change in pixels, and errors that determine that a moving object does not exist when it does may be reduced. To the contrary, the threshold value may be set to a higher value, such that errors that determine that a moving object exists when it does not may be reduced.

If the threshold value is set to an extremely low value to reduce the possibility of missing a moving object, a deep learning model for object detection and tracking is frequently driven, causing performance degradation in multi-stream processing, and therefore, it is desirable to set an appropriate threshold value.

### 2) Step of Recording Videos (S120)

When it is initially determined that a moving object exists, videos may be recorded and stored as a file until it is determined that a moving object does not exist. When a difference between the most recent time at which it is determined that a moving object exists and the current time exceeds t second, it may be determined that a moving object does not exist. For example, if t is 3 seconds, recording videos may be stopped when the difference between the most recent time at which the moving object is determined and the current time exceeds 3 seconds, and the videos may be stored as a file.

When a video file is stored, information when video recording starts and how long recording lasts should be known, so that it is possible to identify when the video is recorded, and to achieve this, the name of a video file may be designated as follows:
{camera id} _{recording start time} _{recording duration}.avi

For example, when the camera ID is “Cam 1”, the recording start time is “2023 Sep. 26 14:09:00, and the recording duration is 40 seconds, the file may be stored in the name of “Cam1_ 2023-09-26-14-09-00_40.avi” to represent the recording start time and the duration.

### 3) Step of Detecting and Tracking an Object (130)

Stored video files may be inserted into a queue in the order that the video files are generated, and may be processed in sequence when there is no occupation of computing resources, and then may be discarded, so that a storage space is always available.

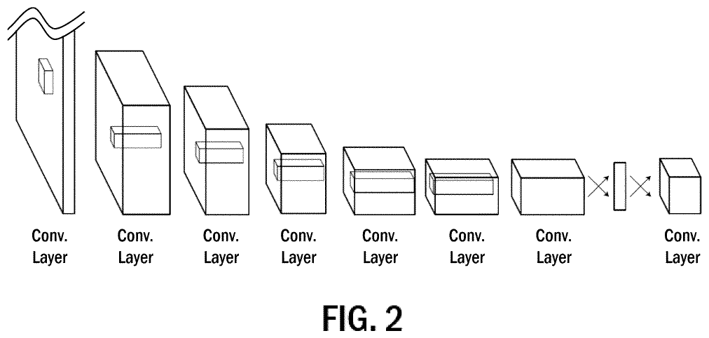

In order to detect a desirable object from a video file, CNN-based YOLO, which is widely used in the object detection field due to its high accuracy and high speed, may be used. FIG. 2 illustrates an artificial neural network structure of CNN-based YOLO.

The artificial neural network of YOLO may include 24 convolutional layers and two fully connected layers, and, when a video image comes in, may output bounding box information (center coordinates (x, y), width, height, etc.) of an object detected from the image as a result.

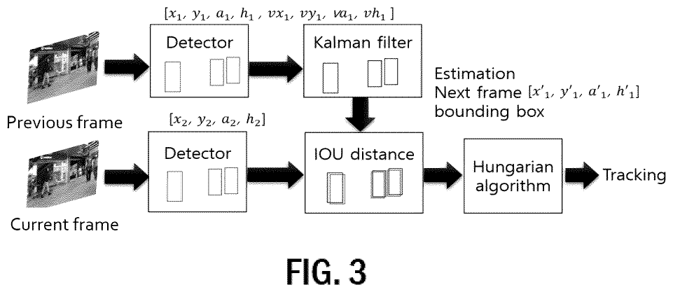

In tracking an object by using the bounding box information acquired through YOLO, simple online real-time tracking (SORT), DeepSORT, ByteTrack, or the like may be used as a real-time object tracking model. Among these, a structure of SORT is illustrated in FIG. 3.

SORT may track movement of an object in each frame by predicting positions in the current frame of all bounding boxes detected from the previous frame through the Kalman filter, then calculating intersection of union (IoU) between the bounding box predicted in the current frame through the Kalman filter and an actual bounding box, and determining a pair of bounding boxes that has the greatest IoU to be the same object among the pairs of bounding boxes with the IoU greater than a threshold value.

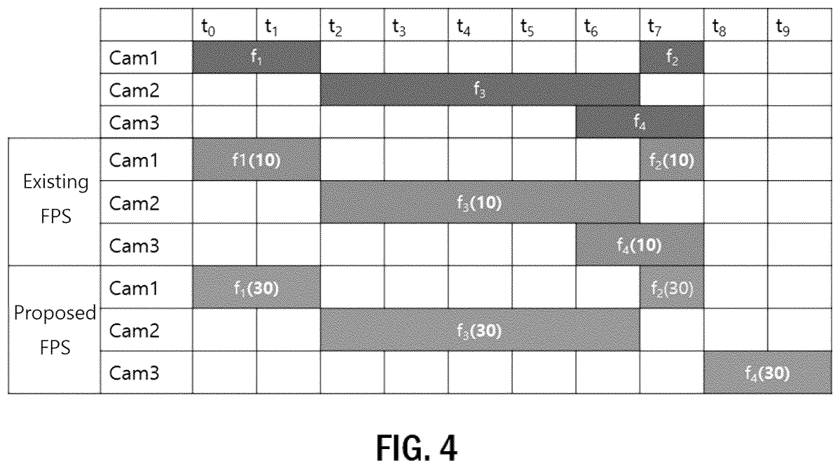

FIG. 4 illustrates comparison of video processing performance between the real-time object tracking method according to an embodiment of the disclosure, and a related-art method.

For example, when a real-time object tracking system with the maximum frame per second (FPS) of 30 processes streams of three cameras and frame (f) having a moving object in each camera streaming comes in at time (t) as shown in FIG. 4, the related-art method generally reduces FPS to 10 in all frames fₓ, but the method according to an embodiment of the disclosure may maintain the maximum FPS of 30.

Since the related-art method should continuously determine whether an object exists by using a deep learning model (YOLO) which requires more computing resources, FPS may be reduced to 10 which is the maxim FPS (30) divided by the number of cameras (3). However, the method according to an embodiment of the disclosure determines whether an object exists simply by comparing pixels, which rarely requires computing resources, and then, stores videos, and processes stored video files in sequence by using a deep learning model (YOLO) when there is no occupation of computing resources, so that the maximum FPS of 30 may be maintained.

In the case of the method according to an embodiment, frame f₄ and frame f₂ end at the same time and one of them should wait until video processing of the other one is completed. However, the waiting time is not long enough to be tolerable in delay-insensitive applications. If frame f₄ and frame f₂ are simultaneously processed to reduce the delay, FPS may be lowered to a level that makes real-time object tracking impossible. Therefore, it is desirable to avoid this.

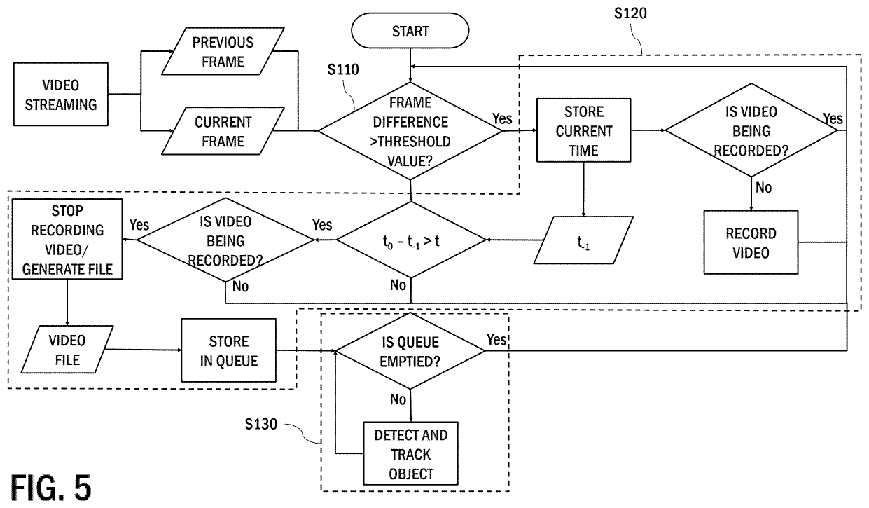

FIG. 5 is a flowchart of a deep learning-based real-time object tracking method according to an embodiment of the disclosure. The step of recording videos (S120) in the above-described steps S110, S120, S130 will be described in detail.

At step S110, the frame difference may be an MSE or an RGA between the previous frame and the current frame, and the threshold value may be a boundary value for determining whether a moving object exists.

At step S120, t₋₁ is the most recent time at which the frame difference is greater than the threshold value (the most recent time at which a moving object exists), to is the current time, and t is a time that it takes to wait to determine that a moving object does not exist. For example, if t is 3 seconds, it may be determined that a moving object does not exist when t₀-t₋₁ is longer than 3 seconds, and video recording may be stopped if video recording is ongoing and a file may be created.

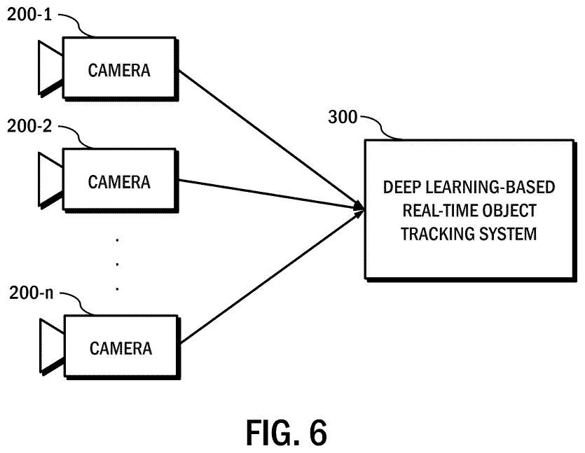

FIG. 6 is a view illustrating a configuration of a real-time object monitoring system according to another embodiment of the disclosure. The real-time object monitoring system according to an embodiment of the disclosure may include a plurality of cameras 200-1, 200-2, . . . , 200-n, and a deep learning-based real-time object tracking system 300.

The plurality of cameras 200-1, 200-2, . . . , 200-n may be installed in different regions to transmit streaming videos on corresponding regions to the deep learning-based real-time object tracking system 300 in real time.

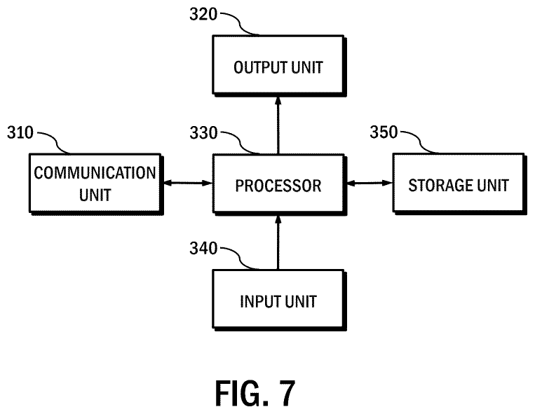

A detailed configuration of the deep learning-based real time object tracking system 300 is illustrated in FIG. 7. As shown in FIG. 7, the deep learning-based real-time object tracking system 300 may be implemented by a computing system which includes a communication unit 210, an output unit 220, a processor 230, an input unit 240, and a storage unit 250.

The communication unit 210, which is a communication interface for connecting to an external network or an external device, may receive streaming videos from the cameras 200-1, 200-2, . . . , 200-n. The output unit 220 is an output means for displaying a result of computing by the processor 230, and the input unit 240 may be a user interface that receives a user command and transmits the same to the processor 230.

The processor 230 may determine whether a moving object exists in multi-streaming videos according to the procedure illustrated in FIG. 1, may record the videos when it is determined that the moving object exists, and may detect and track the object from the recorded video. The storage unit 250 provides a storage space necessary for functions and operations of the processor 230.

Up to now, the deep-learning-based real-time object tracking system and method for minimizing performance degradation in multi-stream processing has been described with reference to preferred embodiments.

The method and system according to the above-described embodiments may minimize occupation of limited computing resources by determining whether a moving object exists in deep learning-based real-time object tracking by comparing pixels between a current frame and a previous frame, rather than determining by a deep-learning model, and may minimize performance degradation even in multi-stream processing by recording a video and storing in a file when the moving object exists and processing video files in sequence when there is no occupation of computing resources.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the disclosure have been illustrated and described, the disclosure is not limited to the above-described specific embodiments. Various changes can be made by a person skilled in the art without departing from the scope of the disclosure claimed in claims, and also, changed embodiments should not be understood as being separate from the technical idea or prospect of the disclosure.

What is claimed is:

1. A real-time object tracking method comprising:
a step of determining whether a moving object exists in a streaming video;
a step of, when it is determined that the moving object exists, recording the streaming video and storing in a file until it is determined that the moving object does not exist; and
a step of detecting and tracking the moving object in the streaming video stored in the file.

2. The real-time object tracking method of claim 1, wherein the step of determining comprises determining whether the moving object exists through a pixel difference between a current frame and a previous frame of the streaming video.

3. The real-time object tracking method of claim 2, wherein the step of determining comprises:
when the pixel difference is less than a threshold value, determining that the moving object does not exist; and
when the pixel difference is greater than or equal to the threshold value, determining that the moving object exists.

4. The real-time object tracking method of claim 3, wherein the threshold value is variable based on a moving object tracking failure rate.

5. The real-time object tracking method of claim 3, wherein the pixel difference is a mean squared error (MSE) or a running Gaussian average (RGA).

6. The real-time object tracking method of claim 1, wherein the step of recording comprises, when a difference between a most recent time at which it is determined that the moving object exists and a current time exceeds a defined time, determining that the moving object which has existed does not exist.

7. The real-time object tracking method of claim 6, wherein, at the step of recording, information on a camera that makes the video, a recording start time, and a recording duration are included in a name of the file.

8. The real-time object tracking method of claim 1, wherein, at the step of recording, the files are stored in a queue in the order that the files are generated, and
wherein the step of detecting and tracking comprises processing the files stored in the queue in sequence when there is no occupation of computing resources.

9. The real-time object tracking method of claim 8, wherein the step of detecting and tracking comprises detecting and tracking the moving object by using a deep learning-based artificial neural network.

10. A real-time object tracking system comprising:
a communication unit configured to receive a streaming video; and
a processor configured to determine whether a moving object exists in the received streaming video, when it is determined that the moving object exists, to record the streaming video and store in a file until it is determined that the moving object does not exist, and to detect and track the moving object in the streaming video stored in the file.

11. A real-time object tracking method comprising:
a step of generating a streaming video;
a step of determining whether a moving object exists in the generated streaming video;
a step of, when it is determined that the moving object exists, recording the streaming video and storing in a file until it is determined that the moving object does not exist; and
a step of detecting and tracking the moving object in the streaming video stored in the file.
